(19) United States
(12) Patent Application Publication
(10) Pub. No.: US 2019/0184963 A1
(43) Pub. Date: Jun. 20, 2019

(54) METHOD FOR OPERATING A DRIVE TRAIN OF A MOTOR VEHICLE

(71) Applicant: ZF Friedrichshafen AG, Friedrichshafen (DE)

(72) Inventor: Axel BLOCHING, Ravensburg (DE)

(21) Appl. No.: 16/222,346

(22) Filed: Dec. 17, 2018

(30) Foreign Application Priority Data
Dec. 19, 2017 (DE) 10 2017 223 274.9

(51) Int. Cl. B60W 10/196; B60T 10/00; B60W 30/18; F16H 45/02; F16H 61/14

(52) U.S. Cl. CPC B60W 10/196; B60T 10/00; B60W 30/18072; F16H 2061/147; F16H 45/02; F16H 61/143; B60W 2710/18; B60W 30/18136

(57) ABSTRACT

A method of operating a drive-train (1) of a motor vehicle, which has a drive aggregate (2), a transmission (3) with a hydrodynamic torque converter (4), an engine brake device (6) and a drive output (5). The engine brake device (6) which is activated when the drive-train (1) is operating in an overdrive mode, during a coasting process, before carrying out an overdrive downshift, when the turbine rotational speed (n_tu) of the torque converter (4) is lower than the engine idling rotational speed (n_mot_LL) of the drive aggregate (2). The engine brake device (6) is deactivated at a point in time chosen such that, when the overdrive downshift is carried out, a load change in the drive-train (1) is avoided.

This application claims priority from German patent application serial no. 10 2017 223 274.9 filed Dec. 19, 2017.

### FIELD OF THE INVENTION

The invention relates to a method for operating a drive-train of a motor vehicle. In addition the invention relates to a control unit for carrying out the method and to a corresponding computer program product.

### BACKGROUND OF THE INVENTION

In vehicle drive-trains known from prior practice, during operation load changes perceptible to a driver occur when changing from traction to overdrive operation or from overdrive operation to traction operation. In traction operation, with its drive torque a drive engine of the vehicle propels the vehicle in the chosen driving direction. In contrast, during overdrive operation, at the output of a drive-train there is produced a drive output torque that drives the vehicle in opposition to the braking torque produced by the drive engine.

Particularly in coasting processes, i.e. during coasting downshifts in low driving speed ranges and coasting of the vehicle down to rest when the accelerator pedal is not actuated, good shifting quality is desirable since the driver cannot count on any striking drive-train reaction. Particularly with automatic transmissions, in which overdrive shifts and especially coasting downshifts are carried out as pure overlapping shifts of two frictional shifting elements without a freewheel as an additional shifting element, as is known the shifting sequence is applicable only with difficulty.

Problematic operating situations, in which due to the load change jerks occur, which are transmitted into the drive-train aside from or during shifts, for example when a so-termed rotational speed crossover of the engine rotational speed variation and the turbine rotational speed variation takes place during coasting processes of a vehicle.

A rotational speed crossover during shifts in the transmission of the drive-train occurs when the turbine rotational speed, which to begin with is lower than the engine rotational speed but due to a downshift in the transmission of the drive-train and the accompanying gear ratio change, increases and at a determinable point in time becomes higher than the engine rotational speed. If the drive output rotational speed falls after the shift while the vehicle is coasting, then at a determinable point in time, in the newly engaged gear ratio the turbine rotational speed too falls below the engine rotational speed.

From DE 10 2008 023 134 A1 a method and device are known, for determining the switch-on and switch-off conditions for an engine brake device of a continuous brake unit of a vehicle. Depending on predetermined driving parameters, a continual brake torque is applied to a drive output shaft of a drive output line by means of brake torque demanded by an engine brake device and by a retarder device, such that the activation and deactivation of the engine brake device are specified as a function of a torque threshold value.

### SUMMARY OF THE INVENTION

Accordingly the purpose of the present invention is to provide a new type of method for operating a drive-train of a motor vehicle. In addition a control unit designed to carry out the said method and a computer program product for carrying out the method are also indicated.

From the process-technological standpoint the objective is achieved with the characterizing features of the independent claims. Furthermore, a control unit for operating a motor vehicle is the object of the independent claims, As regards a computer program product, reference is also made to the independent claims. Advantageous further developments are the object of the subordinate claims and of the description that follows.

A method for operating a drive-train of a motor vehicle is proposed. The drive-train comprises at least a drive aggregate, a transmission with a hydrodynamic torque converter, an engine brake device and a drive output.

The motor vehicle is preferably a utility vehicle, in which during overdrive operation an engine braking effect can be increased by an engine brake device that can be activated additionally in a coasting operation.

The engine brake device is preferably designed as an additional continuous brake device. Thus, for example, the engine brake device can be in the form of an exhaust throttle valve or a constant throttle, or a combined system with an exhaust throttle valve and a constant throttle. The engine brake device can also be a so-termed turbo brake. Likewise, the engine brake device can be in the form of a retarder or an electric machine if these are arranged in the drive-train in such manner that by appropriate control of the retarder or electric machine, the engine braking action during overdrive operation can be increased.

The activation of the engine brake device can be called for by the vehicle's driver by means of an operating element, this operating element for example being arranged on an instrument panel of the motor vehicle.

The drive aggregate of the motor vehicle can be a combustion engine or internal combustion engine, an electric motor or a hybrid drive comprising an internal combustion engine and an electric motor.

The transmission is preferably an automatic or automated transmission which, for example, is designed as an automatic transmission in which, to engage a gear, frictional shifting elements are closed.

The invention is now based on the technical principle that during overdrive operation of the drive-train, during a coasting operation during which an engine brake device is activated, before carrying out an overdrive downshift when a turbine rotational speed of the torque converter is lower than an idling rotational speed of the drive aggregate, the engine brake device is deactivated at a point in time chosen such that when the overdrive downshift is carried out a load change in the drive-train is avoided.

A deactivated engine brake device should on the one hand be understood to mean that the engine braking action in overdrive operation is produced exclusively by the engine braking effect of the drive aggregate, but the engine braking action is no longer increased by the engine brake device. If the engine brake device is designed as a controllable engine brake device, then a deactivated engine brake device should also be understood to mean an actuated engine brake device such that the engine braking torque produced by the still actuated engine brake device has been reduced at least to such an extent that during a subsequent overdrive downshift when the turbine rotational speed of the torque converter is lower than the engine idling rotational speed of the drive aggregate, a load change in the drive-train is avoided.

Thus, during the overdrive downshift a rotational speed crossover of the turbine rotational speed and the rotational speed of the drive aggregate is avoided, whereby the shift quality of the overdrive downshift and the driving comfort during a coasting process of the motor vehicle are improved.

According to an advantageous further development of the invention, it is provided that in a recognized emergency braking or full braking process, a switch-off command for deactivating the engine brake device is ignored and the engine brake device remains actuated beyond the switch-of time determined, in order to assist the emergency braking or full braking process. In this way the motor vehicle can be brought to rest more quickly. An emergency braking or full braking process can be recognized, for example, by virtue of a rapidly released accelerator pedal and a forcefully actuated brake pedal.

The invention also relates to a control unit designed to carry out the method according to the invention. The control unit contains means that serve to carry out the method according to the invention. These means include hardware means and software means. The hardware means of the control device are data interfaces for the exchange of data with assemblies of the transmission involved in carrying out the method according to the invention. The hardware means also include a memory for data storage and a processor for data processing. The software means include program modules for carrying out the method according to the invention.

Thus, to carry out the method according to the invention the control unit contains a receiving interface designed to receive signals from signal emitters. The signal emitters can for example be sensors, which determine measurement variables and send them to the control unit. A signal emitter can also be called a signal sensor. Thus, the receiving interface can receive signals emitted by the signal emitters, which indicate a rotational speed of the drive aggregate or a rotational speed of the turbine shaft of the hydrodynamic torque converter, or by means of which the rotational speed of the drive aggregate or the rotational speed of the turbine shaft of the hydrodynamic torque converter can be determined. The receiving interface can also receive a signal from an operating element by which a command to activate the engine brake device is indicated.

The control unit also comprises a data processing unit for evaluating and/or processing the input signals or the information in the input signals.

The control unit also has a sending interface designed to emit control signals to control elements. Control elements are understood to mean actuators that implement the commands from the control unit. The actuators can for example be in the form of electromagnetic valves. The control unit can for example be designed as a transmission control unit which, to control or regulate the transmission, the engine brake device and the drive aggregate, can emit appropriate control signals to the respective drive-train components.

The system according to the invention can also be incorporated as a computer program product which, when run on a processor of a control device, instructs the processor by software means to carry out the associated process steps which are the object of the invention. In this connection a computer-readable medium also belongs to the invention, on which the above-described computer program product can be stored retrievably.

The invention is not limited to the indicated combination of features specified in the independent claims or the claims that depend on them. There are in addition possibilities for combining individual features with one another provided that they emerge from the claims, the description of embodiments given below, or directly from the figures.

### BRIEF DESCRIPTION OF THE DRAWINGS

Preferred further developments emerge from the subordinate claims and the following description. An example embodiment of the invention, to which it is not limited, is described in greater detail with reference to the drawings, which show:

FIG. 1: An example of a drive-train with an automatic transmission and a hydrodynamic torque converter, represented schematically,

FIG. 2: An example of a rotational speed variation during a coasting process, with conventional actuation of an engine brake device,

FIG. 3: An example of a rotational speed variation during a coasting process, with actuation of an engine brake device in accordance with the invention.

### DETAILED DESCRIPTION OF THE PREFERRED EMBODIMENTS

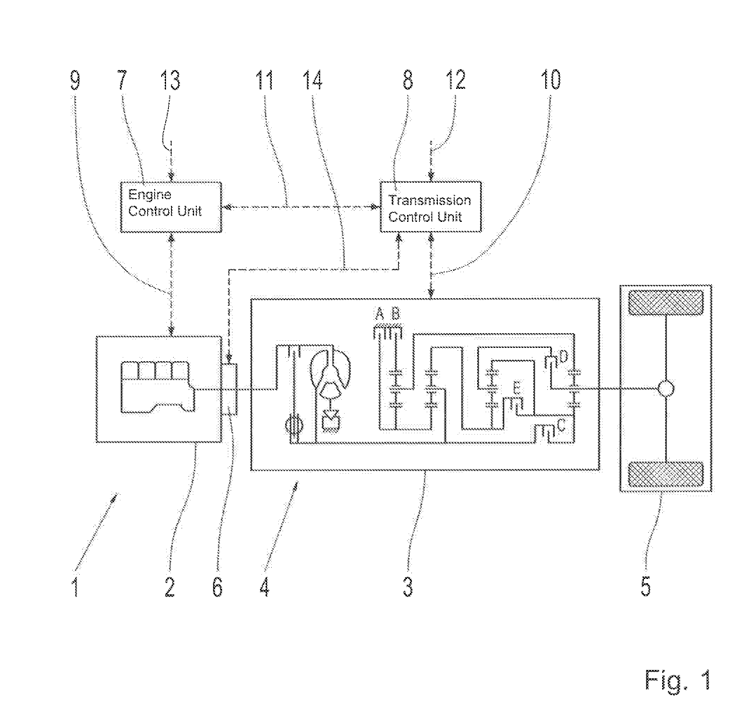

FIG. 1 shows a schematic representation of a drive-train 1 of a motor vehicle, wherein the drive-train 1 shown comprises a drive aggregate 2, a transmission 3, an engine brake device 6 and a drive output 5. The transmission 3 is an automatic transmission connected in the power flow between the drive aggregate 2 and the drive output 5. The drive output is in the form of a drive axle, in this case comprising at least an axle transmission, two driveshafts and two drive wheels. An output shaft of the automatic transmission 3 is in driving connection with the drive wheels of the drive axle by way of the axle transmission and the two driveshafts.

On the input side, a hydrodynamic torque converter 4 provided with a bridging clutch is connected upstream from the automatic transmission 3. The hydrodynamic torque converter 4 comprises a pump wheel and a turbine wheel, the pump wheel being connected, rotationally fixed to a driveshaft of the drive aggregate 2 which can be connected as necessary to an input shaft of the automatic transmission 3 by way of the bridging clutch and a vibration damper. The turbine wheel of the torque converter 4 is connected to the input shaft of the automatic transmission 3.

The automatic transmission 3 shown in FIG. 1 is of planetary configuration and has four gearsets and five shifting elements, the shifting elements being in the form of frictional brakes and frictional clutches. A total of eight forward gears and one reverse gear can be engaged, and in each of these gears three shifting elements are closed and two shifting elements are open. To carry out a gearshift and thus a shifting process, at least one of the previously open shifting elements is closed or engaged and at least one of the previously closed shifting elements is opened or disengaged. The transmission scheme shown in FIG. 1 is presented purely as an example. In addition to frictional shifting elements, interlocking shifting elements can also be present.

Associated with the drive aggregate 2 there is an engine control unit 7 and associated with the automatic transmission 3 there is a transmission control unit 8. The operation of the drive aggregate 2 is controlled and/or regulated with the help of the engine control unit 7, for which purpose the engine control unit 7 exchanges data 9 with the drive aggregate 2. The operation of the automatic transmission 3 is controlled and/or regulated by the transmission control unit 8, for which purpose the transmission control unit 8 exchanges data 10 with the automatic transmission 3. Furthermore, the engine control unit 7 and the transmission control unit 8 exchange data 11 with one another.

According to FIG. 1 sensors (not shown here) provide data 12 to the transmission control unit 8, on the basis of which the transmission control unit 8 controls and/or regulates the operation of the automatic transmission 3, for example data about a position or a degree of actuation of a brake pedal. Other sensors (not shown here) supply further data 13 to the engine control unit 7, on the basis of which the engine control unit 7 controls and/or regulates the operation of the drive aggregate 2, for example data about a position or a degree of actuation of an accelerator or gas pedal.

During traction operation of the drive-train 1, drive torque from the drive aggregate 2 is passed via the hydrodynamic torque converter 4 and the automatic transmission 3 to the drive output 5. In contrast, during overdrive operation of the drive-train 1, starting from the drive output 5, torque in the drive-train 1 is passed via the automatic transmission 3 and the hydrodynamic torque converter 4 in the direction toward the drive aggregate 2. The drive aggregate 2 then delivers engine braking torque which, when the drive aggregate 2 is in the form of an internal combustion engine, is determined essentially by the load change work. The engine brake device 6 is provided in order to increase the engine braking action of the drive aggregate 2 still further during overdrive operation. The operation of the engine brake device 6 can be controlled and/or regulated both by the engine control unit 7 and also by the transmission control unit 8, for which purpose the engine control unit 7 and/or the transmission control unit 8 exchange data 9, 14 with the engine brake device 6.

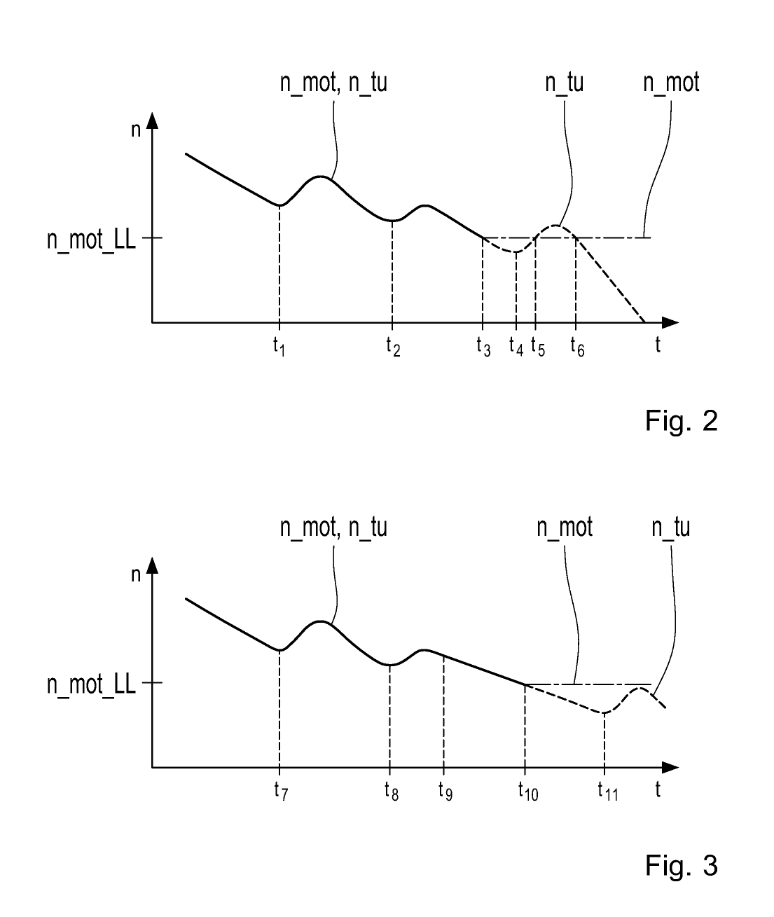

FIG. 2 shows a variation of a turbine rotational speed n_tu and a variation of an engine rotational speed n_mot of the drive aggregate 2 during a conventional coasting process of the motor vehicle. During the coasting process the drive aggregate is operated in overdrive mode. At the beginning of the rotational speed variation the engine brake device 6 is activated, whereby the engine braking action of the drive aggregate 2 is increased. The converter bridging clutch of the hydrodynamic torque converter is closed, which can be recognized in that the variation of the turbine rotational speed n_tu and the variation of the engine rotational speed n_mot overlap. During the coasting process of the motor vehicle, with the converter bridging clutch closed and the engine brake device 6 activated, coasting downshifts are carried out at times t1 and t2. At low rotational speeds the engine braking torque is smaller than at higher rotational speeds. Since after a coasting downshift has been carried out the engine rotational speed n_mot of the drive aggregate 2 is higher again, there is consequently also a higher engine braking torque again after the coasting downshift. When the converter bridging clutch is closed and the engine brake device 6 is activated, it is advantageous while an overdrive downshift is being carried out to deactivate the engine brake device 6. This simplifies the synchronization process when shifting into the new gear, since the braking torque produced by the engine brake device 6 plays no part in the synchronization process.

When an engine idling rotational speed n_mot_LL is reached at time t3, the converter bridging clutch of the torque converter is opened and the engine rotational speed n_mot of the drive aggregate 2 is held at least approximately at the engine idling rotational speed n_mot_LL by an idling control or idling regulation, as shown in FIG. 2 by the dot-dash line n_mot. Since during the coasting process of the motor vehicle its travel speed decreases, the turbine rotational speed n_tu decreases and assumes a course represented by the broken line n_tu,

At time t4 another overdrive downshift is carried out. At that time t4 the turbine rotational speed n_tu is already lower than the engine idling rotational speed n_mot_LL of the drive aggregate 2. Due to the overdrive downshift, the turbine rotational speed n_tu increases again and at time-point t5 crosses over the engine idling rotational speed n_mot_LL of the drive aggregate 2. When the speed of the vehicle decreases after the overdrive downshift during the coasting process, the turbine rotational speed n_tu also falls again in the newly engaged gear to below the engine idling rotational speed n_mot_LL of the drive aggregate 2. Thus, after the overdrive downshifts have been carried out the turbine rotational speed n_tu crosses twice over the engine idling rotational speed n_mot_LL of the drive aggregate 2, so that in the drive-train 1 two undesired load changes take place, which have a negative influence on the driving comfort during the coasting process.

To be able to avoid this two-time crossover of the turbine rotational speed n_tu and the engine idling rotational speed n_mot_LL of the drive aggregate 2 and the concomitant undesired load changes in the drive-train 1, in the method according to the invention a switch-off time is determined for the engine brake device 6 of the motor vehicle which was actuated during the coasting process. FIG. 3 shows a variation of a turbine rotational speed n_tu and a variation of an engine rotational speed n_mot of the drive aggregate 2 during a coasting process of the motor vehicle, with actuation of an engine brake device 6 according to the invention. First, as in FIG. 2, the drive aggregate 2 is operated in an overdrive mode, the engine brake device 6 is active and the converter bridging clutch of the hydrodynamic torque converter is closed. During the coasting process of the motor vehicle, with the converter bridging clutch closed and the engine brake device 6 activated overdrive downshifts are carried out at times t7 and t8.

According to the present invention a switch-off time t9 for the active engine brake device 6 is now determined. It is provided that the engine brake device 6 is deactivated already when an engine rotational speed n_mot of the drive aggregate 2 or a turbine rotational speed n_tu of the torque converter 4 reaches a rotational speed value which is above the engine idling rotational speed n_mot_LL by a certain offset. The offset can be specified variably, for example as a function of a braking gradient of the drive-train 1, a vehicle mass and other boundary conditions such as a switch-off lag time of the engine brake device 6. The braking gradient of the drive-train 1 can for example be determined from the variation of the rotational speed n_mot of the drive aggregate 2, from the variation of the turbine rotational speed n_tu or from the variation of a transmission drive output rotational speed.

The offset can be determined by the transmission control unit 8 which, when the engine rotational speed n_mot of the drive aggregate 2 or the turbine rotational speed n_tu of the torque converter 4 reaches the rotational speed value, emits a control signal for the deactivation of the engine brake device 6 to the engine brake device 6 directly or to the engine control unit 7, which then emits the signal for deactivating the engine brake device 6 to the engine brake device 6.

According to FIG. 3 this rotational speed value is reached at time t9, whereupon the engine brake device 6 is deactivated. Thereafter, a rotational speed variation takes place which is flatter compared with FIG. 2 due to the less pronounced engine braking effect. Due to this less pronounced engine braking action the engine idling rotational speed n_mot_LL is reached at a later time t10, at which the converter bridging clutch of the torque converter 4 opens and the engine rotational speed n_mot of the drive aggregate 2 is held by an idling control or idling regulation at least approximately at the engine idling rotational speed n_mot_LL, as shown in FIG. 3 by the dot-dash line n_mot. Since during the coasting process of the motor vehicle the travel speed decreases, the turbine rotational speed n_tu too is reduced and assumes a variation shown by the broken line n_tu.

The shifting points for the overdrive downshifts carried out during overdrive operation are determined as a function of an existing vehicle deceleration or a magnitude equivalent thereto. Thus, if the vehicle decelerates sharply an overdrive downshift is triggered at an earlier time, i.e. at a higher shift rotational speed, than if the deceleration of the vehicle is less severe. If an engine brake device 6 which is active during the overdrive operation of the drive-train 1 is deactivated, this results in a more gentle deceleration of the vehicle, due to which the shifting point for a subsequent overdrive downshift is displaced and the overdrive downshift is triggered at a later time, i.e. at a lower shift rotational speed.

After the opening of the converter bridging clutch, at time t11 an overdrive downshift is again carried out. Since after the opening of the converter bridging clutch, as shown in FIG. 3 the turbine rotational speed n_tu has a lower rotational speed gradient than the turbine rotational speed n_tu in FIG. 2, in the method according to the invention the overdrive downshift when the turbine rotational speed n_tu of the torque converter 4 is lower than the engine idling rotational speed n_mot_LL can be carried out at a lower shift rotational speed and therefore correspondingly later. In this way a crossover of the turbine rotational speed n_tu, which increases again after the overdrive downshift, with the engine idling rotational speed n_mot_LL, can be avoided and consequently the driving comfort during a coasting process can be improved.

### INDEXES

1 Drive-train
2 Drive aggregate
3 Transmission
4 Torque converter
5 Drive output
6 Engine brake device
7 Engine control unit
8 Transmission control unit data
9 Data
10 Data
11 Data
12 Data
13 Data
14 Data

1-9. (canceled)

10. A method for operating a drive-train (1) of a motor vehicle, which comprises a drive aggregate (2), a transmission (3) with a hydrodynamic torque converter (4), an engine brake device (6) and a drive output (5), the method comprising:
activating the engine brake device (6), when the drive-train (1) is operating in an overdrive mode during a coasting process, before carrying out an overdrive downshift, when a turbine rotational speed (n_tu) of the torque converter (4) is lower than an engine idling rotational speed (n_mot_LL) of the drive aggregate (2), and
selecting deactivation of the engine brake device (6) at a point in time such that when the overdrive downshift is carried out, a load change in the drive-train (1) is avoided.

11. The method according to claim 10, further comprising determining, during the coasting process, either an engine rotational speed (n_mot) of the drive aggregate (2) or a turbine rotational speed (n_tu) of the torque converter (4), and
turning off the engine brake device (6) at a point in time when the rotational speed (n_mot) of the drive aggregate (2) or the turbine rotational speed (n_tu) of the torque converter (4) reaches a rotational speed value which is above the engine idling rotational speed (n_mot_LL) by a certain offset.

12. The method according to claim 11, further comprising taking into account, a braking gradient of the drive-train (1), a current vehicle mass or a switch-off delay time of the engine brake device (6) for either determining the offset or determining the point in time for deactivating the engine brake device (6).

13. The method according to claim 10, further comprising deactivating the engine brake device (6) to carry out the overdrive downshift with the converter bridging clutch of the torque converter (4) engaged.

14. The method according to claim 10, further comprising ignoring a switch-off command to deactivate the engine brake device (6) when an emergency braking operation is recognized, and
maintaining the engine brake device (6) actuated beyond the determined switch-off time to assist the emergency braking.

15. A control unit for operating a drive-train (1) of a motor vehicle, the control unit comprising:
at least a receiving interface designed to receive signals from signal emitters;
a data processing unit designed to process the signals received; and
a sending interface designed to emit control signals to control elements, the control unit deactivating an engine brake device (6), which is activated when the drive-train (1) is operating in an overdrive mode during a coasting process before an overdrive downshift is carried out when a turbine rotational speed (n_tu) of the torque converter (4) is lower than an engine idling rotational speed (n_mot_LL) of the drive aggregate (2), at a point in time chosen such that when the overdrive downshift is carried out, a load change in the drive-train (1) is avoided.

16. The control unit according to claim 15, wherein the control unit comprises control means for carrying out method in which the engine brake device (6), which is activated when the drive-train (1) is operating in an overdrive mode during a coasting process before an overdrive downshift is carried out when a turbine rotational speed (n_tu) of the torque converter (4) is lower than an engine idling rotational speed (n_mot_LL) of the drive aggregate (2), is deactivated at a point in time chosen such that when the overdrive downshift is carried out, a load change in the drive-train (1) is avoided.

17. The control unit according to claim 15, wherein the control unit is designed as a transmission control unit (8).

18. A computer program product with program code means, stored on a computer-readable data carrier, for carrying out a method, wherein an engine brake device (6), which is activated when a drive-train (1) is operating in an overdrive mode during a coasting process before an overdrive downshift is carried out when a turbine rotational speed (n_tu) of a torque converter (4) is lower than an engine idling rotational speed (n_mot_LL) of a drive aggregate (2), the engine brake device (6) is deactivated at a point in time chosen such that when the overdrive downshift is carried out, a load change in the drive-train (1) is avoided, and the computer program product is run on a control unit having at least a receiving interface designed to receive signals from signal emitters, a data processing unit designed to process the signals received, and a sending interface designed to emit control signals to control elements.
